(19) United States
(12) Patent Application Publication
(10) Pub. No.: US 2026/0178771 A1
(43) Pub. Date: Jun. 25, 2026

(54) MULTILAYER SYSTEM AND METHOD FOR SECURING ESTATE DOCUMENTS IN A SINGLE REPOSITORY

(71) Applicant: Gorman Squared LLC, Fort Lauderdale, FL (US)

(72) Inventors: David GORMAN, Fort Lauderdale, FL (US); Mark GORMAN, Fort Lauderdale, FL (US)

(73) Assignee: Gorman Squared LLC, Fort Lauderdale, FL (US)

(21) Appl. No.: 19/416,164

(22) Filed: Dec. 11, 2025

Related U.S. Application Data
(60) Provisional application No. 63/736,806, filed on Dec. 20, 2024.

(51) Int. Cl. G06F 21/62; H04L 9/06; H04L 9/32

(52) U.S. Cl. CPC G06F 21/6245; H04L 9/0631; H04L 9/3249

(57) ABSTRACT

A multi-layer cybersecurity system and method for protecting documents in a digital vault. Specifically, the invention employs AES-256 CTR and RSA 2048 encryption to protect data stored in UTF-16 format in the digital vault. Furthermore, environmental based signature weighting is applied to the keys. As a result, cold signers can do anything hot signers can but hot signers cannot do what cold signers can such as taking control, recovering control, or reconstitute the data of the vault in real time, if necessary.

### RELATED APPLICATIONS

This application claims the priority and benefit of U.S. Provisional Patent Application Ser. No. 63/736,806, titled “multilayer system and method for securing estate documents in a single repository” filed on Dec. 20, 2024, the contents of which are incorporated by reference in their entirety into this application.

### TECHNICAL FIELD

This invention relates generally to a multi-layer cybersecurity system and method for protecting digital files including entered and ingested data from other systems, as well as document(s) and video(s) upload, for The Electronic Guardian (the “Guardian” or the “System”). The objective is to provide the Guardian with the same level of security as a private, non-system saved encryption key, aka the key is not stored on the System, matched with the ability to decrypt the saved data, when the original key is unavailable. Specifically, the invention employs the use of multiple layers of randomly created encryption protocols/keys, The process begins with a per user unique encryption, randomly generated key that is systematically, yet non-uniformly, separated into a new key that is matched into other data, which cryptographically stores and allows access to confidential information in a repository and where said keys are then further encrypted and these new encryption are converted into a QR code and then removed from the System and stored off-line in a non-Internet connected manner.

### BACKGROUND

The digitization and secure management of personal and estate related information has become critical in today's fast-paced and technology-driven world. And while the Guardian was built to house this type of information, the security system and protocols, as well as the ability to regain access to the secured data and information, without compromising the system's security, established and outlined herein, would have far reaching applicability in securing data and information no matter what said data and information is being protected. Personal and estate related information, which include wills, trusts, power of attorney forms, banking relationships, including related assets and liabilities, real estate holdings, public and private investments, life insurance/annuity, historical tax filings and records, copies of critical identification, and other legal and financial papers, are essential for ensuring the smooth transfer of assets and the fulfillment of an individual's final wishes. Traditionally, this information has been stored in physical form, often in law offices, safety deposit boxes, or at home. However, physical documents are vulnerable to damage, loss, theft, or misplacement, which can result in costly legal disputes, delays, and potential financial losses for the owner or in the case of death, the owner's beneficiaries

Digitizing critical information offers significant advantages in terms of accessibility, security, and efficiency. A digital system allows for easy access and retrieval by authorized individuals, even from remote locations, making it easier to manage one's own life during critical times, allowing for a single repository for all vital information and faster, more organized access during the estate planning process, ensuring all assets are known and inventoried. In addition, physical documents are susceptible to deterioration over time, as well as risks from natural disasters like floods, fires, or other unforeseen events. Digital storage ensures that this critical information is preserved in perpetuity, reducing the risk of loss.

Furthermore, as cyber threats become more sophisticated, the need for secure digital storage is paramount. Advanced encryption, multi-factor authentication, and secure cloud storage provide layers of protection that far exceed what is possible with physical documents alone, However, as cyber threats have become more sophisticated, new, more advanced, significantly more secured protocols and systems are required. The use of private, non-stored encryption keys have demonstrated significantly higher levels of digital protection than those systems that use conventional password/user name protocols, those that store encryption keys in their primary software, or where encryption codes are dispersed on a user's individual device. Through all these types of systems, a criminal can gain access by breaking into a system or device, or through a brute force attack. A well-secured digital document management system that utilizes private keys not only protects sensitive personal and financial information but also helps ensure that unauthorized access or tampering is prevented.

The security protocols described herein, offer a significantly advanced level of security, whether built with or without the use of blockchain. The emergence of blockchain provides a unique opportunity for estate planning professional(s). At the most basic level, the keys to access the estate documents will be one or more blockchain-based token(s) that resides on a distributed system which includes multiple nodes, a journal, ledger, and a chain. The multiple nodes communicate with each other and arrive at consensus regarding the validity of transactions appended to their replicated journal(s). Through the use of public/private keys in the cryptographic signing of submitted transactions, entries are made on the journal, which affects state changes for the blockchain-based tokens (i.e., who has copies of the relevant keys) in real time. The speed and access, however, presents certain risks such as how custody will be maintained and what safeguards can be put in place to prevent and address unauthorized access.

The goal of all of these security protocols is to ensure that the digital information is secure, while at the same time, allowing for the recovery of the data, in such a circumstance where the private key is not available. By utilizing a public or private blockchain and distributive ledger technology in conjunction with the multi-layered security model described herein, security issues are addressed. This security assures the safety of the Account Holder's vital financial and material information, documents and videos, while at the same time, ensuring said information can be transferred upon the owner's death, without the need for the owner's private, individual key, all with the objective of not sacrificing the integrity of the private key security.

By utilizing a private key methodology, a key that has to be matched in various parts and pieces that are unique to each full encryption code and concatenated string, there is no means of hacking the System to find and decrypt the housed data. While at the same time, additional layers of encryption and then an off-loading of those new keys as a QR code (“Recovery Key(s)′) to a non-connected device, allows for the ability to decrypt the individual user's contained data when the original user key is unavailable. Note, if a criminal were able to obtain access to the Recovery Keys, which would require the physical attainment of the Recovery Key, they would have no way of knowing where and how to match said Recovery Key (QR Code) to the individual user account within the primary System therefore, not being able to access the System period.

### SUMMARY

The present invention outlines a multi-layered security model for the handling of user (known as the “Account Holder”) vital documents, allowing for a full estate inventory upon the Account Holder's death, while allowing the Account Holder to utilize the System during their life time as a virtual safe deposit box. At the center of this security system and method sits a complex building of an individually created Account Holder key (“AH Key”) that is developed through the use of several individually cryptographically secured keys that are combined and then split at non-uniform points throughout the combined key, removing pieces of this key, and then combining these removed pieces into the AH Key. When said AH Key is entered into the System, the System first matches it to other pieces of the original combined cryptographical keys and places the pieces of the AH Key at the right locations within said remains of the original key to form the full length original combined key which is parsed to then decrypts the underlying keys which used to decrypt the data. To be clear, the AH Key (which is made up of portions of the original cryptographic key) is not housed on the System; only the remaining portions of the original combined cryptographic key remains on the System. The disclosed provides security of a comprehensive repository of an Account Holder's entire information and subsequent estate. In life, the Account Holder's virtual safe deposit box provides them with a one-stop location for all their important accounts, documents, contacts, and other critical matters. Everything at their fingertips. Upon the Account Holder's passing, their Estate Vault, protected by the disclosed security protocols, allows them to leave a legacy or a final gift to their loved ones, presenting a fully transparent and auditable inventory and directives of their estate, melting 280 hours or more of work into mere minutes and ensuring no assets are lost in the transition.

The disclosed method(s) provides the Account Holder with the highest level of security; equivalent to a private, non-stored, encryption key such as that used for Bitcoin, however, the System is able to decrypt the contained data when the original AH Key is unavailable, without compromising the integrity of the private key security. The Recovery Key is created by adding an additional layer of encryption on top of the original keys and then offloading this new second layer of encryption onto a QR code that is downloaded onto a different system that has no connection to the Internet or any other form of outside access. When needed, The Recovery Key is entered into the system to allow for decryption, like an at-rest encryption process, but where said key may be located on a device connected to the Internet (i.e., a hot environment) or a device that is not connected to the Internet (i.e., a cold-environment).

Each Account Holder first establishes a user account. This user account is protected via standard two-factor authentication; email or magic link and a code sent to their mobile phone, whereby the Account Holder enters his or her email whereby an email with a link is sent to their email, and at the same time they are also texted a seven-digit code to their mobile phone, the number which is stored in the user profile, which they then need to enter to reach them main home page. On the main home page, the Account Holder may enter their Estate Vault, which is established and protected by the encryption process described below.

While the system and methods incorporate some standard encryption processes (e.g., AES and RSA), the manner in which the security protocol is enhanced by the entire security process to create: (1) a completed encryption concatenated string, (2) the Account Holder's unique encryption key, and (3) the way in which the disclosed system(s) and method(s) re-encrypt, off load, and store recovery keys, to recover data once an Account Holder has passed or has lost their exclusive encryption key, is unique. It provides the level of security of a private key so if the Estate Vault is hacked, the hacker would not be able to find the encryption key to unscramble the housed data, while at the same time, the System is able to recover the data without the AH key.

Not only can access to estate documents be granted, restricted, or amended in real-time, but oversight guardians or the testator can immediately correct any issues. Indeed, this invention provides the real-time security and transparency sought by testator(s), and estate planning professionals.

This invention is a system or a method for securing digital keys that provide access to documents located within a digital vault. In certain embodiments, the digital keys may be blockchain-based token(s) minted by a token issuer. The system includes a software application and at least one processor of a computer device.

The software application receives an instruction to create new keys or in certain embodiment a state change to the blockchain-based token(s), the instruction received from the testator, token issuer, or oversight guardian. Included with the instruction is a cryptographic signature signed by a separate private key held by the testator or peer and is compared to the stored public key. This signature seeks to authorize the reissuance of keys and may result in the changing of the state of the blockchain-based token(s) from a first state to a second state, which assists with decryption of digital files held in the Estate Vault.

The application also receives an environmental designation, previously configured or uploaded by an employee or agent of the token issuer or oversight guardian, wherein the environmental designation identifies the private key signatures that reside in a hot environment (on a device connected to the Internet) and the private key signatures that reside on a cold environment (a device not connected to the Internet).

In addition, the application receives a signature weight designation, previously configured or uploaded by an employee or agent of the token issuer or oversight guardian. The signature weight designation includes: a signature weight assigned to each key or blockchain-based private key signatures residing primarily in a hot environment, and a signature weight assigned to each key or blockchain-based private key signatures residing primarily in a cold environment. The signature weight assigned to key or signatures residing primarily in the cold environment is greater than the signature weight assigned to keys or signatures primarily residing in the hot environment.

The application also receives a transaction weight designation previously configured or uploaded by an employee or agent of the token issuer or oversight guardian, establishing a minimum signature weight required to effectuate different changes such as state changes to the blockchain-based token(s).

At least one processor is in communication through the wired and/or wireless communication network with the software application. The processor is configured to compare the instruction to the transaction weight designation and determine a minimum signature weight required to effectuate the desired outcome, such as a blockchain state change. The processor also compares the environmental designation to the private key signatures and determine whether the private key or signatures reside in a hot environment or a cold environment. The processor also compares the signature weight designation to the determination of the environment in which the private key signatures reside and determine the aggregate signature weight of the private key signatures. The processor then compares the aggregate signature weight to the minimum signature weight required to make the desired change and, if the aggregate signature weight is greater than or equal to the minimum signature weight required to make the change, then the processor is configured to generate and transmit a proposed transaction containing the change, including an updated timestamp memorializing the date and time of the change and which keys or signatures authorized the change. At all times relevant, at least one processor is configured to monitor the state of the keys and when a change occurs from a first state to a second state without an aggregate signature weight being greater than or equal to the minimum weight required to make the change, at least one processor is configured to issue orders reversing the change.

A method for protecting digital keys is also disclosed. The method includes receiving an instruction from the testator, token issuer, or oversight guardian to make a change to a key. The instruction seeks to authorize the changing of the state or accessibility of the key. An environmental designation, previously configured or uploaded by an employee or agent of the token issuer or oversight guardian, is also received. The environmental designation identifies the private key or signatures that reside in a hot environment and the private key or signatures that reside in a cold environment. A signature weight designation, previously configured or uploaded by an employee or agent of the token issuer or oversight guardian, is also received. The signature weight designation includes: a signature weight assigned to blockchain-based private key signatures residing primarily in a hot environment, and a signature weight assigned to blockchain-based private key signatures residing primarily in a cold environment, wherein the signature weight assigned to private key signatures residing primarily in the cold environment is greater than the signature weight assigned to private key signatures residing primarily in the hot environment. A transaction weight designation previously configured or uploaded by an employee or agent of the token issuer or oversight guardian, is received. The transaction weight designation establishes a minimum signature weight required to effectuate different state changes.

Under the disclosed method, upon receiving the instruction and the transaction weight designation, the method includes comparing the instruction to the transaction weight designation and determining a minimum signature weight required to effectuate the state change. In addition, upon receiving the environmental designation and the private key signatures, the methods include comparing the environmental designation to the private keys and determining whether the private key signatures reside in a hot environment or a cold environment. Upon receiving the signature weight designation and the environment in which the private key signatures reside, the method includes comparing the signature weight designation to the determination of the environment in which the private key signatures reside and determining the aggregate signature weight of the private key signatures. And, upon receiving the aggregate signature weight to the minimum signature weight required to make the state change, the method includes comparing the signature weight designation to the determination of the environment in which the private key signatures reside and determining the aggregate signature weight of the private key signatures.

The method also includes monitoring the state of the data in the Estate Vault and, when there is a change to the data from the first state to the second state without the aggregate signature weight being greater than or equal to the minimum weight required to make the state change, the method further includes issuing orders reversing the change.

### BRIEF DESCRIPTION OF THE DRAWINGS

Additional aspects, features, and advantages of the invention, both as to its structure, assembly, and use, will be understood and will become more readily apparent when the invention is considered in light of the following description of illustrative embodiments made in conjunction with the accompanying drawings, wherein:

FIG. 1 illustrates an embodiment of the multiple layers of security disclosed herein for digitally securing information in a digital vault.

### DETAILED DESCRIPTION

Various embodiments of the systems and processes of the invention are described in detail below. Although specific implementations are described, this is done for illustration purposes only. A person skilled in the relevant art will recognize that other components and configurations may be used without parting from the spirit and scope of this disclosure.

### Blockchain-Based Token(s)

In certain embodiments, the security of a blockchain-based token is at the heart of this invention. A blockchain-based token is a new type of digital file which takes on numerous forms. Regardless of form, the blockchain-based token at its heart is a unit of counting or quantities of an asset-like concept inherent to blockchain technology. In certain embodiments, the blockchain-based token is an issuer-created token (e.g., a token created by an oversight guardian). The networks used to create these issuer-created tokens may be, for example, Ethereum or Stellar.

Regardless of type, the blockchain-based token disclosed herein defines multiple nodes, with a journal, ledger, and a chain. At its core, a blockchain is a distributed system which includes multiple nodes, which communicate with each other. A blockchain-based token in the present invention includes a sequenced list of state changes to tokens secured by the system and method disclosed herein and also operates programs called chaincode (e.g., smart contracts, etc.), which records transactions in a journal, maintains timely account data in a ledger, and executes transactions through the use of smart contracts, which verify that any required investor-specific keys (i.e., a testator or oversight guardian's signature) are present and the required signature weight threshold, if any, is met or exceeded. Some transactions are operations invoked on the chaincode. In certain embodiments, blockchain transactions must be “endorsed” by certain blockchain members (e.g., endorsed by both the testator and an oversight guardian). This endorsement or signature may be a signature-weight-based endorsement discussed below or a member-specific endorsement or signature. Regardless, the smart contracts attached to the token only permit properly endorsed/signed transactions to be committed to the blockchain to affect the state of the blockchain. Other transactions, which are not endorsed, are disregarded. There may also exist one or more special chaincodes for management functions and parameters, collectively called system chaincodes.

Nodes are the communication entities of the blockchain-based token. A “node” may perform a logical function in the sense that multiple nodes of different types can run on the same physical server. Nodes are grouped in trust domains with established trust lines and are associated with logical entities, which control them in various ways. Nodes may include different types, such as a client or submitting-testator node which submits a transaction-invocation to an endorser (e.g., peer such as a spouse or child), and broadcasts transaction-proposals to an ordering service (e.g., ordering node). Another type of node is a peer node that can receive client/testator submitted transactions, commit the transactions, and maintain a state and a copy of the ledger of blockchain transactions. Peers can also have the role of an endorser, although it is not a requirement. An ordering-service-node or “orderer” is a node running the communication service for all nodes, and which implements a delivery guarantee, such as a broadcast to each of the peer nodes in the system when committing transactions and modifying a world state of the blockchain, which is another name for the initial blockchain transaction that normally includes a genesis block having control and setup information.

The journal is a sequenced, tamper-resistant record of all state transitions in the blockchain-based token. State transitions may result from chaincode invocations (e.g., transactions) submitted by participating parties (e.g., client nodes, ordering nodes, endorser nodes, peer nodes, etc.). A transaction results in a set of asset key-value pairs being committed to the journal as one or more operands, such as creates, updates, deletes, and the like. The ledger is a virtual book of participant accounts (which may also include a blockchain), which stores an immutable, classified record of postings. There is typically one ledger showing the current value of the blockchain-based token(s) for each “channel,” which is a relationship based on trust lines between a token issuer and at least one testator holding the blockchain-based token(s). This ledger typically shows wallet address(es) holding blockchain-based tokens; the amount of token(s) held in each wallet; the current value of the blockchain-based token(s); any pending or settled transactions between the peer wallet(s), testator wallet(s), and/or the issuer wallet; and the historical transaction activity for each blockchain-based token. Each peer node maintains a copy of the ledger for each channel in a trust domain of which it is a member. A trust domain is defined by trust lines and establishes a principal relationship between investor(s) and token-issuer(s) as well as any intermediaries.

A chain is a transaction log structured as hash-linked blocks, and each block contains a sequence of N transactions where N is equal to or greater than one. The block header includes a hash of the block's transactions, as well as a hash of the prior block's header. In this way, all transactions on the ledger may be sequenced and linked cryptographically together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys (i.e., signatures), which are included in the chain transaction log. Because the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup and before transactions are accepted.

In certain embodiments operated blockchain technology, embodiments of the systems and methods of the invention disclosed herein permit a supply restriction or key/token recall notice to be executed or, alternatively, to be repealed, in whole or in part, by sharing information and instructing all intermediaries simultaneously. Specifically, the processor is configured to notify the token issuer and any oversight guardian of such orders. In certain embodiments, the smart contract may include a vehicle to appeal the recall notice based on off-chain facts or conditions. As a result, this innovation not only can help token issuers, oversight guardians, beneficiaries and testators protect sensitive information but can also investigate and correct anomalies that can minimize the need for expensive intervention (e.g., lawsuits). This invention allows token issuers to supplement or even pre-empt those issues to the beneficiaries benefit and that of the testator clients. Therefore, this invention permits more precise and dynamic restrictions by addressing individual anomalies and providing auditable trails for the changes of all estate documents.

### Interplay of Hot and Cold Signers

In certain embodiments, the multi-layer security system and method disclosed herein may include both hot signers and cold signers who have varying weights assigned to their keys/signatures based on the environment in which the signer resides. Both hot and cold signing environments use the same software stack—including MPC—and are functionally compatible with each other. In certain embodiments, the difference is simply that the hot signers run in container clusters on virtual machines separated across operating environments (e.g., Azure and AWS), whereas cold signers run on portable hardware primarily disconnected from any network.

Members—such as testators, beneficiaries, oversight guardians, token-issuers, agents of the token-issuer, or employees or agents of an oversight guardian—who store their private keys on a device connected to the Internet (e.g., computer, mobile computer device, tablet, etc.) are known as hot signers because their key(s) reside on devices primarily connected to the Internet, the hot environment. Conversely, members—such as employees or agents of the token-issuer or oversight guardians-who may store their private key(s) on a device running a hardened operating system with MPC shares of relevant private keys stored on an embedded hardware security module that is typically not connected to any network are known as cold signers as they reside outside the hot environment.

Cold signers can do anything hot signers can do, but signature weight guardrails prevent hot signers from taking certain actions reserved for cold signers. An employee or agent of the token issuer or oversight guardian will have previously configured in the system or method a designated environmental multiplier for designated cold signers. For example, cold signers may have a multi-signature weight, which is three (3×) times the multi-signature weight of a hot signer. In such embodiments, there may be four (4) hot signers and six (6) cold signers. Based on this amount of hot and cold signers, an employee or agent of the token issuer or oversight guardian may have previously set the weight threshold for token transfer(s) at two (2) and the weight threshold for wallet rekeying at six (6). With these settings in place, any two hot signers or a hot signer and a cold signer can transfer keys to other individuals. However, it takes at least two (2) cold signers to rekey the data in the Estate Vault because there are only four (4) hot signers, hot signers cannot rekey the data in the Estate Vault.

In other words, hot signers may perform “low” and “medium” category operations, such as setting or storing data elements with the wallet address, establishing trust lines to the wallet(s) of the token issuer, and sending title of documents held in the estate vault. Cold signers can do all operations performed by hot signers. However, cold signers may also perform “high” category operations such as freezing access to the Estate Vault, re-keying of documents in the Estate Vault, and reversing key transfers. Hot-signers cannot perform these “high” category operations.

The weights assigned to cold signer signatures will always be greater than the weights given to hot signer signatures. For example, the weight given to cold signers may be two (2×) to ten (10×) times the weight given to hot signers. Indeed, it may be three (3×), four (4×), five (5×), six (6×), seven (7×), eight (8×), or nine (9×) times that of hot signers.

In certain embodiments, the weights given to cold signer(s) may be further stratified. For example, a cold signer who is an oversight guardian (e.g., a testator's lawyer) may have two (2×) times the weight of a cold signer who is an employee or agent of the token issuer, if the token issuer is different from the oversight guardian.

These environmental guardrails allow a 24/7 online transaction processing setting to effect testator desires with no need to transfer keys back and forth between cold and hot environments. Indeed, the keys may be transferred in a hot environment with the understanding that if an anomaly (e.g., a cyber-attack or unauthorized access to the estate vault) is identified the cold signers could quickly and easily reset the contents of the estate vault to the time right before the anomaly occurred, rekey the data in the estate vault, and reissue keys.

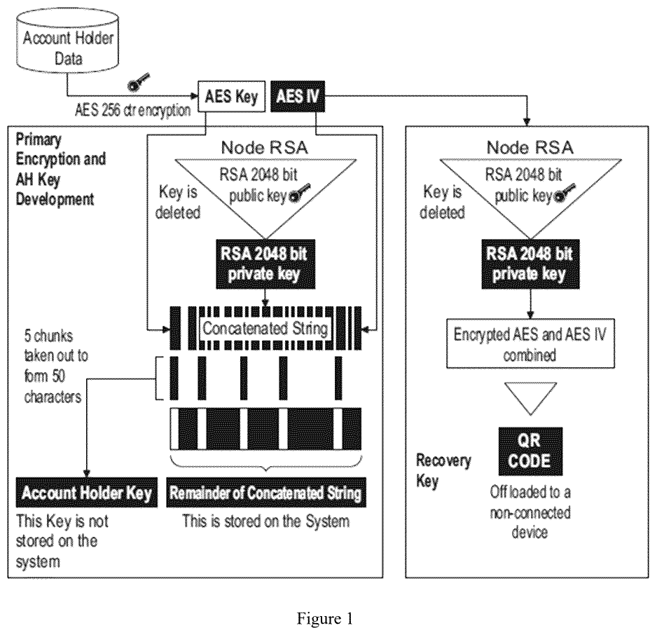

FIG. 1 depicts the manner by which hot signers may operate in the disclosed invention.

### Security Layering

Each Account Holder of the Estate Vault is provided a unique encryption key (“AH Key”). In plain language, the AH Key is established as follows: the system encrypts all the information contained in the Account Holder's Estate Vault (ultimately there are three different strings of encryption). The three strings of encryption are combined into one large, concatenated string. Then for each unique concatenated string, non-uniform parts of this concatenated string are removed and combined into the AH Key. The Account Holder is responsible for saving their AH Key while the System will store the remainder string portion. To recover the protected sensitive information contained within the Estate Vault, the Account Holder must enter their AH Key which is recombined with the remainder portion of the concatenated string stored on the System to form the decryption key, which is then used to decrypt and make the and information contained in the Estate Vault viewable.

In a nonlimiting example, the relevant key(s) are generated as follows. First, the Account Holder's data is encrypted using AES 256 ctr encryption-a combination of a randomly generated AES Key (numbers, letters and symbols) and a randomly generated AES IV (initialization vector—numbers only). Next the system builds a new level of encryption around the AES encryption (one for the AES Key and one for the AES IV). Here, the system and method creates a new, unique RSA 2048 bit public/private key pair. In certain embodiments the system or method uses a node package manager (“npm”) called node-rsa to generate this. Both the AES Key and the AES IV are encrypted with the RSA public key with the RSA public key being the same for both the AES key and AES IV encryption. RSA will also generate a private key. Again, this private key is the same for both AES key and AES decryption. As a result the AES Key and AES IV are encrypted using the generated RSA public key.

In such non-limiting embodiments, there are three unique keys—the RSA private key, the AES key, and the AES IV, which are all needed to decrypt the Account Holder's data. As described below, the system and method builds a totally new concatenated string (“Concatenated String”) that combines the three aforementioned keys.

In such non-limiting embodiments, the system or method takes ten consecutive characters from a fixed position of the RSA private key, then through the following process, randomly inserts the AES Key and AES IV in different parts of the RSA private key. First, a number between 1 and the length of the RSA private key minus ten is chosen (known as the “Starting Position”). Then ten consecutive characters are extracted from the RSA private key at the Starting Position (known as the “Control String”). These ten characters are then used to generate various numbers. Numbers are generated by extracting the numeric portion of the Unicode Transformation Format (UTF) 16-bit encoding of various characters in the Control String. They are then divided to obtain a remainder value which guarantees the numbers will be in a specific range. Next the system or method starts to build the total concatenated string (known as the “Total Concatenated String”). Specifically, the system or method starts with the private key minus the ten characters used for the Control String. An indentation value is generated by character 1 of the Control String between 1 and 150 and a starting value is generated from character 2 of the Control String between 1 and 199. These are combined and that is the starting index where the encrypted IV is inserted into the Total Concatenated String. After the end of the inserted AES IV portion, the system or method moves another 1 to 199 positions as determined by value generated by character 6 of the Control String and at that position, the encrypted AES key is inserted into the Total Concatenated String.

The formation of the AH Key. In simple terms, four chunks of data are taken from the Total Concatenated String and combined with the Control String which creates a string of 50 characters. These four chunks are based on a formula developed from the Total Concatenated String and thus will change form Account Holder to Account Holder, the Total Concatenated String less the four extracted chunks is stored on the System. The Account Holder needs to enter their AH Key, which is then re-housed into the stored portion of the concatenated string to provide the entire de-encryption material (the RSA private key, the AES key and the AES IV), that then unscrambles the data, so it is readable.

Below is the detailed manner by which the AH Key is formed. First, the system or method divides the total length (number of characters) of the total Concatenated String by a number n+1 where n is the number of chunks desired to pull out for the user key. For example, if n is 4 then n+1 is 5. Starting at the index position determined by the length interval value from above the System or method removes the next 8 characters of the total concatenated string to create part 2 of the AH Key. The System or method then moves to the next position which is another length interval value along the total concatenated string and remove another 8 characters. We repeat these removal and advance steps at least 2 more times so in the end we have at least 4, 8-character strings which can be called parts 2 to 5 (known as the “Chunks”). These have been removed from the Total Concatenated String which now becomes the system stored key (known as the “System Key”).

The final piece of creating the AH Key is to embed the lengths of the encrypted AES Key and IV that were combined with the RSA private key. This is used when the AH Key and System key are recombined to pull out these portions of the total concatenated string. Indeed, the lengths of these 2 parts were captured as described above. They may be stored as a 4-digit value allowing for a length of up to 9999 characters. Two index adjustment values between 1 and 3 are created from character 4 for the IV and character 7 for AES Key from the Control String and may be called an IV adjust value and an AES Key adjust value.

Next one digit of the length of both the IV and AES Key is put into parts 2 to 5, the Chunks. In certain embodiments the following algorithms may be used:
Chunk 2: position (4—iv adjust value), set iv length 1^{st} digit, position (4+AES Key adjust value) set AES Key length 4th digit;
Chunk 3: position (iv adjust value), set iv length 2^{nd} digit of iv, position (iv adjust value+AES Key adjust value) set AES Key length 3^{rd} digit;
Chunk 4: position (8—iv adjust value), set iv length 3^{rd} digit, position (8—iv adjust value−AES Key adjust value) set AES Key length 2^{nd} digit;
Chunk 5: position (4+iv adjust value), set iv length 4th digit, position (4−AES Key adjust value) set AES Key length 1^{st} digit.

Now Chunks 2 to 5 each have 10 characters in them. Then the Control String described above is prepended to Chunk parts 2 to 5 to create a 50-character AH Key.

As a result of the need to transfer the housed information post death to other individuals, the information in the Estate Vault needs to be decrypted. without the Account Holder's AH Key, without compromising the tight security around the above discussed encryption process. In summation, the system and method described herein seeks to keep a copy of the AES key and the AES IV, which will allows the Guardian to de-crypt the data. Within the Guardian's backup process the Guardian encrypts the Account Holder's AES key and AES IV with a new, unique RSA 2048 bit public/private key pair, which is then offloaded as a QR code file and transferred to a system that is not connected to the Internet (i.e., a cold-environment) and optionally a back-up paper copy, housed in a locked safe.

In a non-limiting embodiment, the steps of the disclosed method are as follows. First, a new, unique RSA 2048 bit public/private key pair is created. Such embodiments may use a npm package called node-rsa to generate this. Next, the AES Key and AES IV are encrypted using the generated RSA public key. Then, the 2 encrypted strings are combined and then converted into a qr code image using, for example, npm package qrcode. The qr code image is saved as a file to a staging area. The RSA private key is stored on the system. Next a device, which only connects to the internet to either copy these backup files or put them back on the system, is used to upload the staged files. Then, a verification process is conducted via a csharp function that gets the private key and makes sure it can successfully read the first part of the uploaded file. If the verification process passes the file will be deleted from the staging area and the aes key and iv will be removed from the backup key table. Finally, a second and third copy of the uploaded files is saved to a usb drive that is protected by Bitlocker and a paper copy stored in a locked safe.

For decryption purposes when the AH Key is unavailable, the QR code image file can be loaded back onto the system which will permit the recovery of the AES Key and AES IV. This data will be recovered to the system so that user data can be accessed.

Moving forward, a discussion of the methods surrounding the multi-layer security system and method using the invention to protect sensitive estate documents is provided below. First, an outline of the system and method is presented. Second, the components of the system are discussed. Third, a description of a cloud computing system, the preferred environment of the system, is then disclosed.

### System Overview

The example embodiments are directed to systems, methods, devices, networks, non-transitory computer readable media, and/or systems, which support a multi-layer security solution to secure cryptographic keys and/or blockchain-based tokens that provide access to estate data held in an estate vault. More specifically, the invention provides security for the keys. Some of the benefits of such a solution include streamlined risk management and auditability reporting or oversight. Such a security integration allows estate professionals, optionally token issuers, testators, and intermediaries to manage and report changes to the information contained in the testator's estate vault to whomever the testator wishes, as well as to increase security for all interested parties, including beneficiaries, by a) improving the transparency of the changes; b) reporting changes to relevant stakeholders previously authorized by the testator, and doing so in real time; and c) providing oversight guardians, such as lawyers and other estate planning professionals or third party escrow agents, with the ability to investigate and if necessary reset the estate vault holdings if an anomaly (e.g., unauthorized change/manipulation or a cyber-attack) is detected that provide access to data held in an Estate Vault. More specifically, the invention provides security for the keys.

As outlined above, multiple keys which are each cryptographically secured are protected by the disclosed invention. FIG. 1 depicts one embodiment of the digital security layers of the disclosed invention which provide the necessary digital security without sacrificing transparency so that the keys may reside in a hot environment but still provide secure access to the data housed in the Estate Vault.

### AES-256 CTR Encryption

AES-256 CTR encryption is a symmetric encryption method where a 256-bit key is used for both encryption and decryption, providing a high level of security. The CTR (Counter) mode is one of the operational modes of AES that turns it into a stream cipher, making it efficient and easily parallelizable. In AES-256 CTR, encryption begins with the establishment of a 256-bit key and the generation of a unique nonce or initialization vector (IV), which ensures that each encryption session starts with a unique value. The nonce is combined with an initial counter value, typically set to zero, to generate the input for the encryption process.

AES is then applied to this nonce-counter combination, producing a keystream block. The data to be encrypted, known as plaintext, is divided into 128-bit blocks (since AES processes data in 128-bit blocks). The generated keystream is XORed with each block of plaintext to create the ciphertext. For each subsequent block, the counter is incremented, ensuring that a new keystream block is generated for each portion of the data. This process continues until all blocks of plaintext are encrypted.

One of the advantages of AES-256 in CTR mode is that encryption of each block can be performed independently, allowing for parallel processing, which increases efficiency. Moreover, because CTR mode does not require padding, it can handle plaintexts of any length. However, it is crucial that the nonce or IV is never reused with the same key, as this could lead to the reuse of the keystream, compromising the security of the encryption. Proper key management is also essential for maintaining the integrity of the encryption process. By transforming AES into a stream cipher, CTR mode ensures flexibility and performance, making it a popular choice for high-speed encryption tasks.

### RSA 2048 Encryption

RSA-2048 is an asymmetric encryption algorithm that uses a pair of keys: a public key for encryption and a private key for decryption. The term “2048” refers to the length of the key, which is 2048 bits long, making it highly secure for modern encryption standards. RSA encryption is widely used in secure communications, such as SSL/TLS, where sensitive data like passwords or credit card information needs to be protected during transmission.

The security of RSA is based on the mathematical difficulty of factoring large prime numbers. The public key is derived from two large prime numbers and is composed of two values: the modulus (n) and the public exponent (e). The private key is linked to the same modulus but uses a private exponent (d) for decryption. Since only the private key can decrypt data encrypted with the public key, RSA ensures secure communication.

The encryption process using RSA-2048 begins by generating a public-private key pair. The public key is shared with others, while the private key is kept secret. When someone wants to send an encrypted message, they use the recipient's public key. The plaintext data to be encrypted is first transformed into a number smaller than the modulus (n). This number is then raised to the power of the public exponent (e) and reduced modulo n to generate the ciphertext. Mathematically, the encryption formula is depicted below as Formula 1:

$$C = {M}^{e} mod n \qquad Formula 1$$

where C is the ciphertext, M is the plaintext as a number, e is the public exponent, and n is the modulus.

To decrypt the ciphertext, the recipient uses their private key. The ciphertext is raised to the power of the private exponent (d) and reduced modulo n to recover the original message. The decryption, Formula 2, is below:

$$M = {C}^{d} mod n \qquad Formula 2$$

where M is the recovered plaintext, C is the ciphertext, d is the private exponent, and n is the modulus.

Because RSA operates on numbers, in practice, plaintext is first converted into a numeric format through encoding schemes like PKCS #1 or OAEP (Optimal Asymmetric Encryption Padding) to ensure that the message fits within the modulus size and avoids certain security vulnerabilities. RSA-2048 encryption is generally used to encrypt small blocks of data, such as keys for symmetric encryption (e.g., AES), rather than large amounts of data directly, due to its slower processing speed compared to symmetric encryption algorithms.

In summary, RSA-2048 encrypts data by transforming it into a number, raising it to the power of the public exponent, and reducing it modulo a large number. The encrypted data can only be decrypted using the corresponding private key, ensuring secure communication.

### Unicode Transformation Format (UTF)

UTF-16 (Unicode Transformation Format-16-bit) is a character encoding used to represent text in computers and other devices that handle textual data. It is part of the Unicode standard, which aims to represent every character from every writing system in the world. UTF-16 is a variable-length encoding that uses either 16-bit or 32-bit code units to represent characters.

In UTF-16 encoding, most commonly used characters, such as those from the Basic Multilingual Plane (BMP), are encoded as a single 16-bit unit. The BMP includes characters from languages like English, Latin, Greek, and many others. For example, the ASCII characters (which represent letters, digits, and symbols) are encoded directly as their 16-bit equivalents, which are just padded versions of their 8-bit ASCII codes.

However, for characters outside the BMP, such as certain rare characters, emoji, or historical scripts, UTF-16 uses surrogate pairs. A surrogate pair is a combination of two 16-bit code units (each 16 bits long, totaling 32 bits) to encode a single character. In this case, the first 16-bit code unit is called a “high surrogate,” and the second is called a “low surrogate.” Together, they represent a single character outside the BMP.

The structure of UTF-16 makes it efficient for encoding a wide range of characters, but it is not as space-efficient as UTF-8 for text primarily made up of ASCII characters, since UTF-16 uses 16 bits (2 bytes) for even the simplest characters. However, it is more space-efficient than UTF-32, which uses 4 bytes per character regardless of the character's complexity.

Another aspect of UTF-16 is endianness: since it uses 16-bit units, there can be differences in how these units are stored. UTF-16 comes in two flavors: UTF-16BE (big-endian) and UTF-16LE (little-endian), depending on the order in which the two bytes of the 16-bit code units are stored. To help software determine the endianness of a UTF-16 file or data stream, a byte order mark (BOM) is often placed at the beginning. This BOM is a special character that indicates whether the data is in big-endian or little-endian format.

Simply put, UTF-16 is a variable-length encoding that uses 16-bit units to represent most characters and surrogate pairs for characters outside the Basic Multilingual Plane. While it is more efficient for non-ASCII characters compared to UTF-8, it requires more storage for texts composed primarily of ASCII characters. The endianness of UTF-16 can be either big-endian or little-endian, with the byte order mark indicating the format.

### System Components

The system includes a general-purpose computing device, including a processing unit (CPU or processor), and a system bus that couples various system components including the system memory such as read only memory (ROM) and random-access memory (RAM) to the processor. The System includes a storage device connected to the processor by the system bus. The System can include interfaces connected to the processor by the system bus. The System can include a cache of high-speed memory connected directly with, in close proximity to, or integrated as pmi of the processor. The System can copy data from the memory and/or a storage device to the cache for quick access by the processor. In this way, the cache provides a performance boost that avoids processor delays while waiting for data. These and other modules stored in the memory, storage device or cache can control or be configured to control the processor to perform various actions. Other system memory may be available for use as well. The memory can include multiple different types of memory with different performance characteristics.

### Computer Processor

It can be appreciated that the invention may operate on a computing device with more than one processor or on a group or cluster of computing devices networked together to provide greater processing capability. The processor can include any general-purpose processor and a hardware module or software module, stored in an external or internal storage device, configured to control the processor as well as a special-purpose processor where software instructions are incorporated into the actual processor design. The processor may essentially be a completely self-contained computing system, containing multiple cores or processors, a bus, memory controller, cache, etc. A multi-core processor may be symmetric or asymmetric.

For clarity of explanation, an illustrative system embodiment is presented as including individual functional blocks including functional blocks labeled as a “processor”. The functions such blocks represent may be provided through the use of either shared or dedicated hardware, including, but not limited to, hardware capable of executing software and hardware, such as a processor, that is purpose-built to operate as an equivalent to software executing on a general-purpose processor. For example, the functions of one or more processors may be provided by a single shared processor or multiple processors and use of the term “processor” should not be construed to refer exclusively to hardware capable of executing software. Illustrative embodiments may include microprocessor and/or digital signal processor (DSP) hardware, ROM for storing software performing the operations discussed below, and RAM for storing results. Very large-scale integration (VLSI) hardware embodiments, as well as custom VLSI circuitry in combination with a general-purpose DSP circuit, may also be provided.

### System Bus

The system bus may be any of several types of bus structures including a memory bus or memory controller, a peripheral bus, and a local bus using any of a variety of bus architectures. A basic input/output (BIOS) stored in ROM or the like, may provide the basic routine that helps to transfer information between elements within the computing device, such as during start-up.

### Storage Device

The computing device can further include a storage device such as a hard disk drive, a magnetic disk drive, an optical disk drive, a solid-state drive, a tape drive or the like. Similar to the system memory, a storage device may be used to store data files, such as location information, menus, software, wired and wireless connection information (e.g., information that may enable the mobile device to establish a wired or wireless connection, such as a USB, Bluetooth or wireless network connection), and any other suitable data. Specifically, the storage device and/or the system memory may store code and/or data for carrying out the disclosed techniques among other data.

In one aspect, a hardware module that performs a particular function includes the software component stored in a non-transitory computer-readable medium in connection with the necessary hardware components, such as the processor, bus, display, and so forth, to carry out the function. The basic components are known to those of skill in the art and appropriate variations are contemplated depending on the type of device, such as whether the device is a small, handheld computing device, a desktop computer, or a computer server.

Although the preferred embodiment described herein employs cloud computing and cloud storage, it should be appreciated by those skilled in the art that other types of computer readable media which can store data that are accessible by a computer, such as magnetic cassettes, flash memory cards, digital versatile disks, cartridges, RAM, ROM, a cable or wireless signal containing a bit stream and the like, may also be used in the operating environment. Furthermore, non-transitory computer-readable storage media as used herein include all computer-readable media, with the sole exception being a transitory propagating signal per se.

### Interface

To enable user interaction with the computing device, an input device represents any number of input mechanisms, such as a microphone for speech, a touch-sensitive screen for gesture or graphical input, keyboard, mouse, motion input, speech and so forth. An output device can also be one or more of a number of output mechanisms known to those of skill in the art such as a display screen, speaker, alarm, and so forth. In some instances, multimodal systems enable a user to provide multiple types of input to communicate with the computing device. The communications interface generally governs and manages the user input and system output. Furthermore, one interface, such as a touch screen, may act as an input, output and/or communication interface.

There is no restriction on operating on any particular hardware arrangement and therefore the basic features here may easily be substituted for improved hardware or firmware arrangements as they are developed.

### Software Operations

The logical operations of the various embodiments disclosed are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the recited methods, can be a part of the recited systems, and/or can operate according to instructions in the recited non-transitory computer-readable storage media. Such logical operations can be implemented as modules configured to control the processor to perform particular functions according to the programming of the module. For example, if a storage device contains modules configured to control the processor. These modules may be loaded into RAM or memory at runtime or may be stored as would be known in the art in other computer-readable memory locations. Having disclosed some components of a computing system, the disclosure now turns to a description of cloud computing, which is the preferred environment of the invention.

### Cloud System

Cloud computing is a type of Internet-based computing in which a variety of resources are hosted and/or controlled by an entity and made available by the entity to authorized users via the Internet. A cloud computing system can be configured, wherein a variety of electronic devices can communicate via a network for purposes of exchanging content and other data. The system can be configured for use on a wide variety of network configurations that facilitate the intercommunication of electronic devices. For example, each of the components of a cloud computing system can be implemented in a localized or distributed fashion in a network.

### Cloud Resources

The cloud computing system can be configured to include cloud computing resources (i.e., “the cloud”). The cloud resources can include a variety of hardware and/or software resources, such as cloud servers, cloud databases, cloud storage, cloud networks, cloud applications, cloud platforms, and/or any other cloud-based resources. In some cases, the cloud resources are distributed. For example, cloud storage can include multiple storage devices. In some cases, cloud resources can be distributed across multiple cloud computing systems and/or individual network enabled computing devices. For example, cloud computing resources can communicate with a server, a database, and/or any other network enabled computing device to provide the cloud resources.

In some cases, the cloud resources can be redundant. For example, if cloud computing resources are configured to provide data backup services, multiple copies of the data can be stored such that the data is still available to the user even if a storage resource is offline, busy, or otherwise unavailable to process a request. In another example, if a cloud computing resource is configured to provide software, the software can be available from different cloud servers so that the software can be served from any of the different cloud servers. Algorithms can be applied such that the closest server or the server with the lowest current load is selected to process a given request.

### User Terminals

A user interacts with cloud computing resources through user terminals connected to a network by direct and/or indirect communication. Cloud computing resources can support connections from a variety of different electronic devices, such as servers; desktop computers; mobile computers; handheld communications devices (e.g., mobile phones, smart phones, tablets); set top boxes; network-enabled hard drives; and/or any other network-enabled computing devices. Furthermore, cloud computing resources can concurrently accept connections from and interact with multiple electronic devices. Interaction with the multiple electronic devices can be prioritized or occur simultaneously.

Cloud computing resources can provide cloud resources through a variety of deployment models, such as public, private, community, hybrid, and/or any other cloud deployment model. In some cases, cloud computing resources can support multiple deployment models. For example, cloud computing resources can provide one set of resources through a public deployment model and another set of resources through a private deployment model.

In some configurations, a user terminal can access cloud computing resources from any location where an Internet connection is available. However, in other cases, cloud computing resources can be configured to restrict access to certain resources such that a resource can only be accessed from certain locations. For example, if a cloud computing resource is configured to provide a resource using a private deployment model, then a cloud computing resource can restrict access to the resource, such as by requiring that a user terminal access the resource from behind a firewall.

### Service Models

Cloud computing resources can provide cloud resources to user terminals through a variety of service models, such as software as a service (SaaS), platforms as a service (PaaS), infrastructure as a service (IaaS), and/or any other cloud service models. In some cases, cloud computing resources can provide multiple service models to a user terminal. For example, cloud computing resources can provide both SaaS and IaaS to a user terminal. In some cases, cloud computing resources can provide different service models to different user terminals. For example, cloud computing resources can provide SaaS to one user terminal and PaaS to another user terminal.

### User Interaction

In some cases, cloud computing resources can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources such as servers or database.

Cloud computing resources can provide a variety of functionality that requires user interaction. Accordingly, a user interface (UI) can be provided for communicating with cloud computing resources and/or performing tasks associated with the cloud resources. The UI can be accessed via an end user terminal in communication with cloud computing resources. The UI can be configured to operate in a variety of client modes, including a fat client mode, a thin client mode, or a hybrid client mode, depending on the storage and processing capabilities of cloud computing resources and/or the user terminal. Therefore, a UI can be implemented as a standalone application operating at the user terminal in some embodiments. In other embodiments, a web browser-based portal can be used to provide the UI. Any other configuration to access cloud computing resources can also be used in the various embodiments.

While this subject matter has been disclosed with reference to specific embodiments, it is apparent that other embodiments and variations can be devised by others skilled in the art without departing from the true spirit and scope of the subject matter described herein.

What is claimed is:

1. A multi-layer cybersecurity system for protecting one or more estate vault(s) holding estate documents and other critical information, the system comprising:
a software application, the application operating on a mobile computer device or on a computer device, in communication with a estate professional, a testator, an oversight guardian, and, optionally a token issuer or Account Holder the application is configured to receive:
an instruction to make a digital key, the instruction received from the testator, token issuer, or oversight guardian or Account Holder
at least one private key, the private key authorizing access to data in an Estate Vault;
an environmental designation, previously configured or uploaded by an employee or agent of the System, wherein the environmental designation identifies the private keys that reside in a hot environment and the private keys that reside in a cold environment;
a signature weight designation, previously configured or uploaded by an employee or agent of the token issuer or oversight guardian, wherein the signature weight designation includes:
a signature weight ascribed to private keys residing primarily in a hot environment, and
a signature weight ascribed to private keys residing primarily in a cold environment, wherein the signature weight ascribed to private keys residing primarily in the cold environment is greater than the signature weight ascribed to private keys primarily residing in the hot environment; and
a transaction weight designation previously configured or uploaded by an employee or agent of the token issuer or oversight guardian, establishing a minimum signature weight required to effectuate different changes to the keys;
a processor in communication through the wired and/or wireless communication network with the software application, the processer is configured to:
compare the instruction to the transaction weight designation and determine a minimum signature weight required to effectuate the change;
compare the environmental designation to the private keys and determine whether the private keys reside in a hot environment or a cold environment;
compare the signature weight designation to the determination of the environment in which the private keys reside and determine the aggregate signature weight of the private keys submitted; and
compare the aggregate signature weight to the minimum signature weight required to make the change and, if the aggregate signature weight is greater than or equal to the minimum signature weight required to make the change, the processor is configured to generate and transmit the change, including an updated timestamp memorializing the date and time of the change;
wherein, the processor is further configured to monitor the state of the data in an estate vault and when a change occurs from a first state to a second state without the aggregate signature weight being greater than or equal to the minimum weight required to make the change, the processor is configured to issue orders:
reversing the change, and
optionally, instructing the oversight guardian to prohibit any future changes to the data in the estate vault by a party other than the testator, token issuer, or oversight guardian.

2. The system of claim 1, wherein the application further implements a multi-layer encryption scheme in which data in the Estate Vault is encrypted using AES-256 in CTR mode with a randomly generated AES key and initialization vector (IV), and the AES key and IV are each encrypted using an RSA-2048 public key prior to storage or transmission.

3. The system of claim 1, wherein the processor is further configured to form, for each Account Holder, a Total Concatenated String by combining: (i) an RSA private key; (ii) an encrypted AES key; and (iii) an encrypted AES IV, and to compute insertion indices for (ii) and (iii) within the RSA private key based on numeric values derived from UTF 16 code units of a Control String comprising ten consecutive characters of the RSA private key.

4. The system of claim 1, wherein the application is further configured to generate an Account Holder key (AH Key) by removing at least four non-uniform 8-character chunks from the Total Concatenated String at interval-based positions and prepending the Control String to the removed chunks to produce a 50-character AH Key, while storing the remaining System Key on the system.

5. The system of claim 1, wherein the environmental designation assigns higher signature weights to private keys residing in a cold environment than to private keys residing in a hot environment, the weights for cold signers being between two (2×) and ten (10×) the weights of hot signers.

6. The system of claim 1, wherein the transaction weight designation differentiates among operation categories, such that “high” category operations comprising freezing access to an Estate Vault, re-keying documents in an Estate Vault, and reversing key transfers require an aggregate signature weight achievable only with at least a threshold number of cold signers.

7. The system of claim 1, wherein the processor is further configured to generate, offload, and store Recovery Keys by: encrypting the AES key and AES IV with a newly generated RSA-2048 public key, combining the resulting encrypted strings, converting the combination to a QR code image, and transferring the QR code image to a non-Internet-connected device for storage, with optional additional storage on a BitLocker-protected USB device and paper printout in a locked safe.

8. The system of claim 1, wherein the application implements a verification process that, upon uploading a staged QR code file, retrieves a corresponding RSA private key, validates readable content of the uploaded file, and upon successful verification deletes the staged file and removes any corresponding AES key and IV entries from a backup key table.

9. The system of claim 1, wherein hot signers are enabled to perform low and medium category operations including: setting or storing data elements with a wallet address, establishing trust lines to token-issuer wallet(s), and sending title of documents held in the Estate Vault; and wherein cold signers are additionally enabled to perform high category operations including freezing access, re-keying, and reversing key transfers.

10. The system of claim 1, wherein the processor continuously monitors for anomalies comprising state changes lacking a sufficient aggregate signature weight, and upon detecting such an anomaly automatically issues orders reversing the change and optionally instructs the oversight guardian to prohibit future changes by parties other than the testator, token issuer, or oversight guardian.

11. A method for securing one or more estate vault(s) holding estate documents and other critical information, the method comprising:
receiving:
an instruction to make a change to a key, the instruction received from a testator, token issuer, or oversight guardian;
at least one private key signature, the private key signature authorizing the changing of the state of the key from a first state to a second state;
an environmental designation, previously configured or uploaded by an employee or agent of the token issuer or oversight guardian, wherein the environmental designation identifies the private key signatures that reside in a hot environment and the private key signatures that reside in a cold environment;
a signature weight designation, previously configured or uploaded by an employee or agent of the token issuer or oversight guardian, wherein the signature weight designation includes:
a signature weight ascribed to private key signatures residing primarily in a hot environment, and
a signature weight ascribed to private key signatures residing primarily in a cold environment, wherein the signature weight ascribed to private key signatures residing primarily in the cold environment is greater than the signature weight ascribed to private key signatures primarily residing in the hot environment; and
a transaction weight designation previously configured or uploaded by an employee or agent of the token issuer or oversight guardian,
establishing a minimum signature weight required to effectuate different state changes to the keys;
upon receiving the instruction and the transaction weight designation, comparing the instruction to the transaction weight designation and determining a minimum signature weight required to effectuate the state change;
upon receiving the environmental designation and the private key signatures comparing the environmental designation to the private keys and determining whether the private key signatures reside in a hot environment or a cold environment;
upon receiving the signature weight designation and the environment in which the private key signatures reside, comparing the signature weight designation to the determination of the environment in which the private key signatures reside and determining the aggregate signature weight of the private key signatures;
upon receiving the aggregate signature weight to the minimum signature weight required to make the state change and the minimum signature weight required to make the state change, comparing the signature weight designation to the determination of the environment in which the private key signatures reside and determining the aggregate signature weight of the private key signatures; and
monitoring the state of the keys and when a state change to the keys changes from the first state to the second state without the aggregate signature weight being greater than or equal to the minimum weight required to make the state change, issuing orders:
resetting the state of the keys to the first state, and optionally, instructing the oversight guardian to prohibit any changes to the estate vault by parties other than the testator, token issuer, or oversight guardian.

12. The method of claim 2, further comprising encrypting data in the Estate Vault using AES-256 in CTR mode with a randomly generated AES key and IV, encrypting the AES key and IV with an RSA-2048 public key, and storing only the encrypted AES materials with the data to facilitate decryption upon authorized state changes.

13. The method of claim 2, wherein generating indices for inserting an encrypted AES IV and an encrypted AES key into an RSA private key includes deriving numeric values from UTF 16 encodings of characters of a Control String comprising of ten consecutive characters of the RSA private key, computing an indentation value between 1 and 150 and a starting value between 1 and 199, and inserting the encrypted AES materials at positions based on those values to form a Total Concatenated String.

14. The method of claim 2, further comprising forming an AH Key by dividing the Total Concatenated String into intervals based on its total length and a selected number n of chunks, removing at least four 8-character chunks at successive interval positions, embedding digits representing lengths of the encrypted AES IV and AES key into predetermined positions within the chunks using index adjustment values derived from the Control String, and prepending the Control String to produce a 50-character AH Key.

15. The method of claim 2, wherein the environmental designation assigns a greater signature weight to private key signatures residing in a cold environment than to private key signatures residing in a hot environment, including a multiplier of at least three (3×) for cold signers relative to hot signers in certain configurations.

16. The method of claim 2, wherein the transaction weight designation defines thresholds such that any two hot signers or a hot signer and a cold signer can authorize a token transfer, while at least two cold signers are required to authorize re-keying of data in the Estate Vault.

17. The method of claim 2, further comprising generating Recovery Keys for use when the AH Key is unavailable by encrypting the AES key and IV with a newly generated RSA-2048 public key, combining the encrypted strings, converting the combination into a QR code image, staging and uploading the QR file to a non-Internet-connected device, verifying the file using a corresponding RSA private key, and upon verification deleting staged files and removing AES materials from backup tables, and then storing redundant copies on a BitLocker-protected USB drive and as a paper copy in a locked safe.

18. The method of claim 2, wherein hot signers are permitted to perform low and medium category operations comprising setting or storing data elements with a wallet address, establishing trust lines to token-issuer wallet(s), and sending title of documents, and cold signers are additionally permitted to perform high category operations comprising freezing access, re-keying documents, and reversing key transfers.

19. The method of claim 2, further comprising continuously monitoring the state of the keys and reversing any state change from the first state to the second state that lacks an aggregate signature weight greater than or equal to the required minimum, and optionally instructing the oversight guardian to prohibit further changes by parties other than the testator, token issuer, or oversight guardian.

20. The method of claim 2, wherein the receiving of the instruction includes receiving a cryptographic signature signed by a separate private key held by the testator or a peer, comparing the signature to a stored public key, and, upon validation and satisfaction of the minimum signature weight, generating and transmitting a proposed transaction with an updated timestamp memorializing the change and authorizing keys or signatures.
